(19) United States
(12) Patent Application Publication
(10) Pub. No.: US 2019/0301401 A1
(43) Pub. Date: Oct. 3, 2019

(54) ROCKET FUEL PUMP

(71) Applicant: IHI Corporation, Koto-ku (JP)

(72) Inventors: Taiichi MOTOMURA, Tokyo (JP); Hatsuo Mori, Tokyo (JP); Hiroyuki Sakaguchi, Tokyo (JP)

(73) Assignee: IHI Corporation, Koto-ku (JP)

(21) Appl. No.: 16/443,584

(22) Filed: Jun. 17, 2019

Related U.S. Application Data
(63) Continuation of application No. PCT/JP2017/037696, filed on Oct. 18, 2017.

(30) Foreign Application Priority Data
Apr. 3, 2017 (JP) 2017-073690

(51) Int. Cl. F02K 9/48; F01D 15/08; F01D 25/12; F01D 25/16

(52) U.S. Cl. CPC F02K 9/48; F01D 25/162; F01D 25/125; F01D 15/08

(57) ABSTRACT

The present invention provides a rocket fuel pump including a rotating body (4) mounted on a rotating shaft (3) and pressure-feeding rocket fuel when the rotating body (4) is rotationally driven by a drive source (T), and the rocket fuel pump includes a magnetic coupling (R) which is configured to magnetically couple the rotating shaft (3) and a drive shaft (10) of the drive source (T).

### CROSS-REFERENCE TO RELATED APPLICATION

This application is a continuation application based on PCT Patent Application No. PCT/JP2017/037696, filed on Oct. 18, 2017, whose priority is claimed on Japanese Patent Application No. 2017-73690, filed on Apr. 3, 2017. The contents of both the PCT application and the Japanese Patent Applications are incorporated herein by reference.

### TECHNICAL FIELD

The present disclosure relates to a rocket fuel pump.

### BACKGROUND ART

Patent Document 1 below discloses a rocket engine. In this rocket engine, fuel (a liquid propellant) is pressure-fed to a combustion chamber by a first pump and a second pump (rocket fuel pump) which are driven by a turbine. The fuel described above is a cryogenic propellant such as, for example, liquefied methane, liquefied natural gas, liquid oxygen, or liquid hydrogen.

### CITATION LIST

### Patent Document

### [Patent Document 1]

Japanese Unexamined Patent Application, First Publication No. 2014-159769

### SUMMARY OF INVENTION

### Technical Problem

Incidentally, since the rocket fuel pump described above has a structure in which a rotating shaft is rotatably supported by a casing using a mechanical bearing, a fuel (fluid) leakage path is formed between the rotating shaft and the casing. In this rocket fuel pump, although the leakage amount of fuel (fluid) can be reduced by providing a sealing mechanism between the rotating shaft and the casing, the leakage amount of fuel (fluid) cannot be made zero and the leaked fuel is inevitably discarded.

In disposable rocket engines, there is no major problem in discarding leaked fuel. However, in a rocket engine of a type that is used over a long period of time in orbit, disposal of leaked fuel is a major problem since it is directly related to the service life of the engine.

The present disclosure has been made in view of the above circumstances, and it is an objective thereof to prevent rocket fuel from leaking through a rotating shaft of a rocket fuel pump.

### Solution to Problem

To achieve the above-described objective, a first aspect of the present disclosure is a rocket fuel pump including a rotating body mounted on a rotating shaft and pressure-feeding rocket fuel when the rotating body is rotationally driven by a drive source, and the rocket fuel pump includes a magnetic coupling which is configured to magnetically couple the rotating shaft and a drive shaft of the drive source.

### Effects of Invention

According to the present disclosure, since the magnetic coupling that magnetically couples the rotating shaft and the drive shaft of the drive source is provided, rocket fuel can be prevented from leaking through the rotating shaft.

### BRIEF DESCRIPTION OF DRAWINGS

FIG. 1 is a cross-sectional view showing an overall configuration of a rocket fuel pump according to one embodiment of the present disclosure.

FIG. 2A is a cross-sectional view taken along line A in FIG. 1.

FIG. 2B is a cross-sectional view taken along line B in FIG. 1.

FIG. 2C is a cross-sectional view taken along line C in FIG. 1.

### DESCRIPTION OF EMBODIMENTS

Hereinafter, one embodiment of the present disclosure will be described with reference to the drawings.

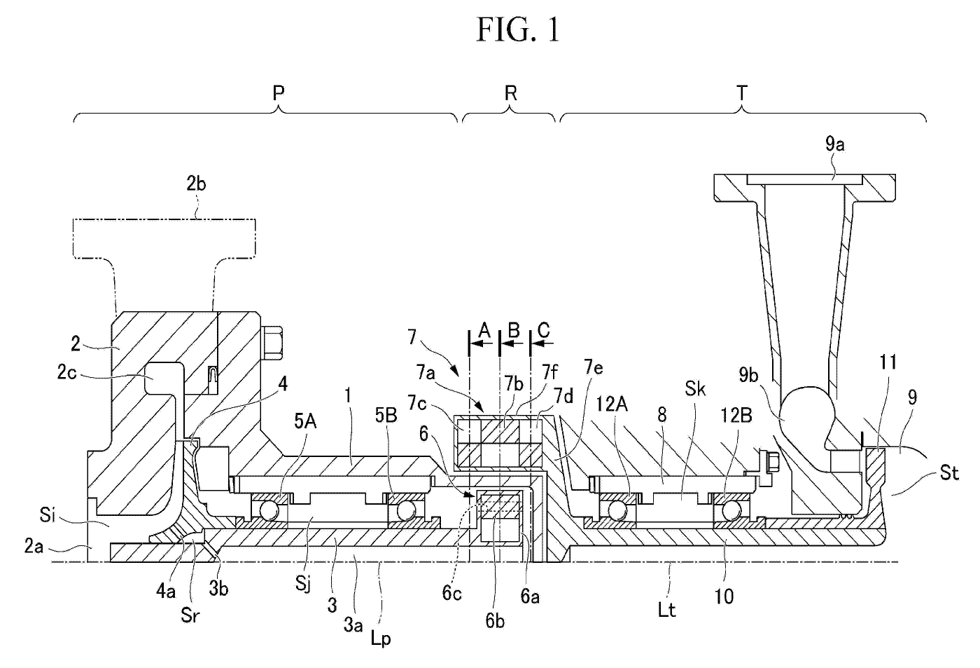

In FIG. 1, a reference sign P denotes a pump, a reference sign T denotes a turbine, and a reference sign R denotes a magnetic coupling. A rocket fuel pump according to the present embodiment is constituted by the pump P and the magnetic coupling R and is rotationally driven by the turbine T serving as a drive source.

The pump P is a rotary machine for pressure-feeding rocket fuel and includes a pump bearing casing 1, a pump casing 2, a rotating shaft 3, a pump impeller 4, and two pump bearings 5A and 5B as shown in FIG. 1. The pump bearing casing 1 may be, for example, a cast product and an accommodating space Sj for accommodating the rotating shaft 3 and the two pump bearings 5A and 5B is formed therein. The accommodating space Sj is a substantially cylindrical space (cylindrical space) having a central axis.

The pump casing 2 is fixed to one end (the left end in FIG. 1, hereinafter abbreviated as “left end”) of the pump bearing casing 1, and an accommodating space Si for accommodating the pump impeller 4 is formed therein. That is, this pump casing 2 is provided on one side (the left side in FIG. 1, hereinafter abbreviated as “left side”) in a central axis direction of the cylindrical accommodating space Sj. The above-described accommodating space Si is a space communicating with one end (the left end) of the accommodating space Sj and includes a suction port 2a for suctioning rocket fuel formed in a central portion on one side (the left side). Also, a discharge port 2b is formed in a direction perpendicular to the central axis in the accommodating space Si. This discharge port 2b is an opening for discharging the rocket fuel and communicates with the accommodating space Si via a scroll flow path 2c.

The rotating shaft 3 is supported by the pump bearing casing 1 via the two pump bearings 5A and 5B. That is, the rotating shaft 3 is a rod-shaped member of a predetermined length accommodated in the accommodating space Sj via the two pump bearings 5A and 5B so that a rotation central axis Lp is coaxial with a central axis of the accommodating space Si. Since the rotating shaft 3 is supported by the pump bearing casing 1 via the two pump bearings 5A and 5B, the rotating shaft 3 is rotatable around the rotation central axis Lp.

As shown in FIG. 1, a cavity 3a is formed in the rotating shaft 3. This cavity 3a is a cylindrical hole of a predetermined length formed along the rotation central axis Lp at the center of the rotating shaft 3, the other end (the right end in FIG. 1, hereinafter abbreviated as “right end”) is open to the accommodating space Sj, and one end is closed in the vicinity of an inner side of the pump impeller 4 except for communication holes 3b to be described below. Also, the communication holes 3b communicating with the one end of the cavity 3a are formed in the rotating shaft 3. The communication holes 3b are cylindrical holes that allow the cavity 3a and a space Sr formed on a surface of the rotating shaft 3 to communicate with each other, and the plurality of communication holes 3b are radially provided. Also, the space Sr is an annular space surrounded by the surface of the rotating shaft 3 and an inner surface of the pump impeller 4 inserted at one end (the left end) of the rotating shaft 3.

The pump impeller 4 is a wheel (rotating body) fixed to the one end (the left end) of the rotating shaft 3 as described above. That is, the pump impeller 4 is fixed to the rotating shaft 3 by inserting the one end of the rotating shaft 3 into a fastening hole formed at a rotational center. This pump impeller 4 sends rocket fuel that has flowed into the accommodating space Si from the suction port 2a to the scroll flow path 2c by rotating together with the rotating shaft 3 around the rotation central axis Lp.

Communication holes 4a are formed in the pump impeller 4. The communication holes 4a are cylindrical holes that allow the accommodating space Si and the space Sr to communicate with each other, and the plurality of communication holes 4a are radially provided as in the above-described communication holes 3b of the rotating shaft 3.

The two pump bearings 5A and 5B are provided at a predetermined distance in an extending direction of the rotation central axis Lp of the rotating shaft 3 and support the rotating shaft 3 to be rotatable with respect to the pump bearing casing 1 which is a fixed system. The pump bearings 5A and 5B described above may be, for example, ball bearings.

The magnetic coupling R is a coupling device for magnetically coupling the rotating shaft 3 and a drive shaft 10 of the turbine T (drive source) and includes a driven coupling part 6 and a drive coupling part 7. The driven coupling part 6 includes a driven side holding member 6a and a plurality of (eight) driven side magnets 6b. The driven side holding member 6a is a disc fixed to the other end (right end) of the rotating shaft 3, that is, on a side of the rotating shaft 3 opposite to the pump impeller 4 in a posture perpendicular to the rotation central axis Lp. That is, the driven side holding member 6a is a disc with the rotation central axis Lp of the rotating shaft 3 as a center and has a predetermined thickness in an extending direction of the rotation central axis Lp.

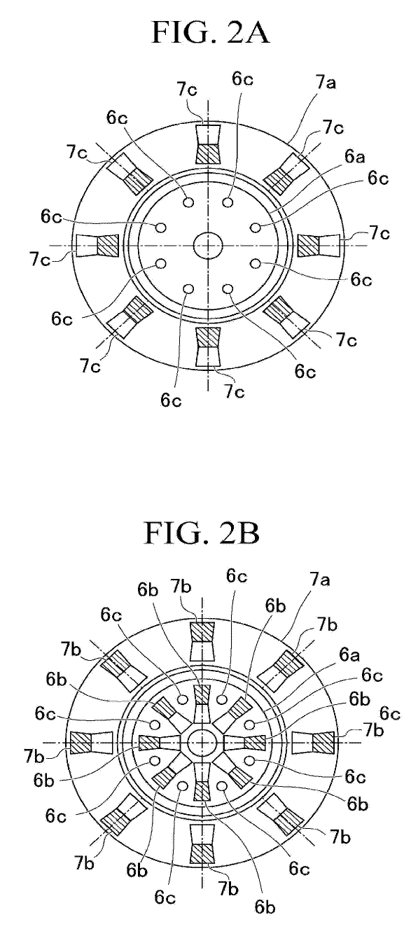

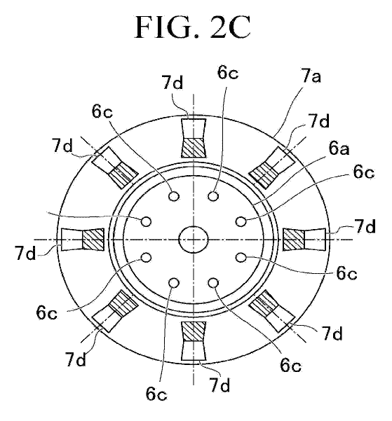

As shown in FIG. 2B, in the driven side holding member 6a, cooling holes 6c are formed between the driven side magnets 6b which are radially aligned. That is, the plurality of (eight) cooling holes 6c are formed in the driven side holding member 6a at a predetermined angular pitch (45° pitch) around the center (the rotation central axis Lp).

As shown in FIG. 1 and FIGS. 2A to 2C, the cooling holes 6c are through holes that cause a pair of circular surfaces facing each other in the driven side holding member 6a to communicate with each other, and rocket fuel can freely flow therethrough. That is, the cooling holes 6c are magnet cooling flow paths for forcibly cooling the driven side magnets 6b disposed adjacent to each other using a flow of the rocket fuel.

The plurality of (eight) driven side magnets 6b are provided in the driven side holding member 6a as described above and are provided in an annular shape at a predetermined angular pitch (45° pitch) as shown in FIG. 2B around the rotation central axis Lp of the rotating shaft 3, that is, around the center of the driven side holding member 6a. The driven side magnets 6b are permanent magnets having S poles and N poles and are fixed to the rotating shaft 3 through the disc-shaped driven side holding member 6a.

Also, the driven side magnets 6b are fixed to the driven side holding member 6a in such a posture that virtual line segments each of which connecting a center of S pole and a center of N pole overlap virtual line segments radially extending at the above-described angular pitch (45° pitch) from the center of the driven side holding member 6a (rotation central axis Lp) toward a circumferential edge which forms a circular shape of the driven side holding member 6a. Further, in the driven side magnets 6b shown in FIG. 2B, hatched portions are N poles and white portions are S poles.

Also, as shown in FIG. 2B, the driven side magnets 6b have a deformed columnar shape in which outer diameters of both ends in an axial direction thereof are larger than an outer diameter of a central portion and are fitted into a plurality of (eight) embedding holes formed in an annular shape at a predetermined angular pitch (45° pitch) on the driven side holding member 6a. That is, the embedding holes are formed in substantially the same shape as the driven side magnets 6b and hold the driven side magnets 6b in a fixed state. Further, the driven side holding member 6a holding the driven side magnets 6b as described above is formed of a material having as little magnetoresistance as possible, that is, a material through which magnetic lines of force emitted from the driven side magnets 6b pass easily.

As shown in FIG. 1, the driven coupling part 6 configured as above is accommodated in the accommodating space Sj as in the rotating shaft 3 and the two pump bearings 5A and 5B. That is, among the driven coupling part 6 and the drive coupling part 7 which constitute the magnetic coupling R, the driven coupling part 6 is accommodated inside the pump bearing casing 1.

On the other hand, the drive coupling part 7 includes a drive side holding member 7a, and a plurality of main drive side magnets 7b and sub drive side magnets 7c and 7d. The drive side holding member 7a is a bottomed cylindrical member provided on one end (the left end) of the drive shaft 10, that is, on a side of the drive shaft 10 opposite to a turbine disc 11. That is, the drive side holding member 7a includes a bottom part 7e fixed to the one end (the left end) of the drive shaft 10 and a cylindrical part 7f having one end continuous with the bottom part 7e. The bottom part 7e is a disc-shaped portion centered on a rotation central axis Lt of the drive shaft 10, and the cylindrical part 7f is a cylindrical portion having a predetermined length in an extending direction of the rotation central axis Lt of the drive shaft 10.

The main drive side magnets 7b and the sub drive side magnets 7c and 7d are drive side magnets provided in the drive side holding member 7a as described above and are provided in an annular shape at a predetermined angular pitch (45° pitch) around the rotation central axis Lt of the drive shaft 10 as shown in FIGS. 2A to 2C. The main drive side magnets 7b and the sub drive side magnets 7c and 7d are permanent magnets having S poles and N poles and are fixed to the drive shaft 10 through the drive side holding member 7a.

These main drive side magnets 7b and the sub drive side magnets 7c and 7d are fixed to the cylindrical part 7f of the drive side holding member 7a in such a posture that virtual line segments connecting centers of S poles and centers of N poles overlap virtual line segments extending radially at the above-described angular pitch (45° pitch) from the center of the drive side holding member 7a (rotation central axis Lt) toward a circumferential edge which forms a circular shape of the drive side holding member 7a. Further, in FIGS. 2A to 2C, N poles of the main drive side magnets 7b and the sub drive side magnets 7c and 7d are shown as hatched portions, and S poles are shown as white portions.

Also, as shown in FIGS. 2A to 2C, as in the driven side magnets 6b described above, the main drive side magnets 7b and the sub drive side magnets 7c and 7d have deformed colunmar shapes in which outer diameters of both ends in an axial direction thereof are larger than outer diameters of central portions and are fitted into a plurality of (eight) embedding holes formed in an annular shape at a predetermined angular pitch (45° pitch) on the drive side holding member 7a. That is, these embedding holes are formed in substantially the same shape as the main drive side magnets 7b and the sub drive side magnets 7c and 7d and hold the main drive side magnets 7b and the sub drive side magnets 7c and 7d in a fixed state.

The main drive side magnets 7b among the main drive side magnets 7b and the sub drive side magnets 7c and 7d are provided to face the driven side magnets 6b as shown in FIG. 1 and to have an annular shape with the same angular pitch (45° pitch) as that in the driven side magnets 6b as shown in FIG. 2B.

In contrast, the sub drive side magnets 7c and 7d are provided to sandwich the main drive side magnets 7b in an extending direction of the rotation central axis Lt as shown in FIG. 1, and postures thereof are set to have a polarity opposite to that of the main drive side magnets 7b as shown in FIG. 1 and FIGS. 2A to 2C. That is, the sub drive side magnets 7c and 7d are provided to have the same polarity as the driven side magnets 6b.

Further, the drive side holding member 7a holding the main drive side magnets 7b and the sub drive side magnets 7c and 7d is formed of a material having as little magnetoresistance as possible as in the driven side holding member 6a described above.

That is, the drive side holding member 7a is formed of a material through which magnetic lines of force emitted from the main drive side magnets 7b and the sub drive side magnets 7c and 7d pass easily.

Incidentally, as shown in FIG. 1, the turbine T includes a turbine bearing casing 8, a turbine casing 9, the drive shaft 10, the turbine disc 11, two turbine bearings 12A and 12B, and the like. As in the pump bearing casing 1, the turbine bearing casing 8 may be, for example, a cast product and an accommodating space Sk for accommodating the drive shaft 10 and the two turbine bearings 12A and 12B is formed therein. The accommodating space Sk is a substantially cylindrical space (cylindrical space) having a central axis.

The turbine casing 9 is fixed to the other end of the turbine bearing casing 8, and an accommodating space St for accommodating the turbine disc 11 is formed therein. That is, the turbine casing 9 is provided on the other side (the right side in FIG. 1) in a central axis direction of the accommodating space St. The above-described accommodating space St is a space communicating with the right end of the accommodating space Sk. In the accommodating space St, a supply port 9a is formed in a direction perpendicular to the central axis. The supply port 9a communicates with the accommodating space St via a scroll flow path 9b and is an opening to which a high-pressure drive fluid is supplied. Although not shown, an exhaust port for exhausting the above-described drive fluid is formed at a right central portion of the turbine casing 9.

The drive shaft 10 is supported by the turbine bearing casing 8 via the two turbine bearings 12A and 12B. That is, the drive shaft 10 is a rod-shaped member of a predetermined length accommodated in the accommodating space Sk via the two turbine bearings 12A and 12B so that the rotation central axis Lt is coaxial with a central axis of the accommodating space Sk. Since the drive shaft 10 is supported by the turbine bearing casing 8 via the two turbine bearings 12A and 12B, the drive shaft 10 is rotatable around the rotation central axis Lt.

The turbine disc 11 is a wheel mounted on the other end (the right end) of the drive shaft 10 as described above. That is, the turbine disc 11 is supported by the drive shaft 10 and rotates around the rotation central axis Lt of the drive shaft 10. When the drive fluid flowing in from the scroll flow path 9b is injected to the turbine disc 11, the turbine disc 11 generates rotational power.

The two turbine bearings 12A and 12B are provided at a predetermined distance in an extending direction of the rotation central axis Lt of the drive shaft 10 and support the drive shaft 10 to be rotatable with respect to the turbine bearings 12A and 12B which are fixed systems. The turbine bearings 12A and 12B as described above may be, for example, ball bearings.

Next, an operation of the rocket fuel pump according to the present embodiment will be described in detail.

The pump P is magnetically coupled to the turbine T (driving source) by interposing the magnetic coupling R therebetween. That is, rotational power of the turbine T is transmitted to the rotating shaft 3 of the pump P through the magnetic coupling R, the rotating shaft 3 is driven by the rotational power, and thereby the pump impeller 4 rotates.

As a result, rocket fuel is flowed in the accommodating space Si from the suction port 2a and is sent from a surface of the pump impeller 4 to the scroll flow path 2c. Then, the rocket fuel is supplied to a combustion chamber from the discharge port 2b via the scroll flow path 2c.

Here, as a more detailed description of the power transmission operation of the magnetic coupling R, in the magnetic coupling R, when the plurality of (eight) driven side magnets 6b provided in an annular shape at the predetermined angular pitch (45° pitch) in the driven side holding member 6a of the driven coupling part 6 and the plurality of (eight) main drive side magnets 7b provided in an annular shape at the same predetermined angular pitch (45° pitch) in the drive side holding member 7a of the drive coupling part 7 respectively face each other with different polarities from each other as shown in FIG. 2B, a magnetic attracting force acts between the drive side holding member 7a and the main drive side magnets 7b, respectively.

As a result, the driven side holding member 6a (the rotating shaft 3) rotates in conjunction (driven) with rotation of the drive shaft 10, that is, in accordance with rotation of the drive side holding member 7a. That is, in the pump P, when the rotating shaft 3 synchronously rotates with respect to the drive shaft 10 of the turbine T, the pump impeller 4 rotates, and thereby the rocket fuel is discharged toward the combustion chamber.

According to the rocket fuel pump as described above, since the magnetic coupling R that transmits rotational power of the turbine T (drive source) to the rotating shaft 3 in a non-contact manner by magnetically coupling the rotating shaft 3 to the drive shaft 10 is provided, leakage of the rocket fuel (fluid) through the rotating shaft 3 can be reliably prevented.

Also, in the magnetic coupling R, sub drive side magnets 7c are provided adjacent to one side of the main drive side magnets 7b and sub drive side magnets 7d are provided adjacent to the other side of the main drive side magnets 7b in an extending direction of the rotation central axes Lp and Lt. Since the sub drive side magnets 7c and 7d provided to sandwich the main drive side magnets 7b as described above are provided to have a polarity opposite to that of the main drive side magnets 7b, that is the same polarity as that of the driven side magnets 6b of the driven coupling part 6, a magnetic repulsive force acts between the driven side magnets 6b and the sub drive side magnets 7c and between the driven side magnets 6b and the sub drive side magnets 7d.

Due to the repulsive force, displacement of the rotating shaft 3 in the extending direction of the rotation central axis Lp is restricted. That is, the driven side magnets 6b and the sub drive side magnets 7c and 7d function as thrust bearings which inhibit displacement of the rotating shaft 3 against a thrust force acting on the rotating shaft 3. Therefore, according to the rocket fuel pump of the present embodiment, since the thrust bearings utilizing the magnetic repulsive force as described above is provided, the rotating shaft 3 (pump impeller 4) can be stably rotated with respect to the thrust force acting on the rotating shaft 3.

Also, while the rocket fuel that has flowed into the accommodating space Si from the suction port 2a is sent to the scroll flow path 2c from the surface of the pump impeller 4 by rotation of the pump impeller 4, some of the rocket fuel flows into the accommodating space Sj through a gap existing on a back surface of the pump impeller 4, continues to flow from the accommodating space Sj through the cavity 3a, the communication hole 3b, the space Sr, and the communication hole 4a, and then returns to the surface of the pump impeller 4, that is, to the accommodating space Si.

That is, the pump P of the present embodiment includes a bearing cooling flow path through which the rocket fuel flows via the pump bearings 5A and 5B. Therefore, according to the pump P as described above, the pump bearings 5A and 5B that generate heat in accordance with rotation of the rotating shaft 3 can be effectively cooled using the rocket fuel. Thereby, the rotating shaft 3 (pump impeller 4) can be stably rotated.

Further, the driven side magnets 6b generate heat mainly due to a magnetic interaction with the main drive side magnets 7b, but a plurality of cooling holes 6c (magnet cooling flow paths) are formed in the driven side holding member 6a of the driven coupling part 6. By the rocket fuel flowing through the cooling holes 6c, the driven side magnets 6h provided in the vicinity of the cooling holes 6c are cooled. Therefore, according to the rocket fuel pump of the present embodiment, the driven coupling part 6 can be effectively cooled.

Further, the present disclosure is not limited to the above-described embodiment, and the following modified examples can be considered, for example.

(1) In the above-described embodiment, eight driven side magnets 6b in total, eight main drive side magnets 7b in total, and eight for each of sub drive side magnets 7c and 7d in total are provided at a predetermined angular pitch (45°), but the present disclosure is not limited thereto. The number (number of poles) of driven side magnets 6b, main drive side magnets 7b, and sub drive side magnets 7c and 7d may be any number as long as it is two (angular pitch=180°) or more, for example.

(2) In the above-described embodiment, the number (number of poles) of driven side magnets 6b and the number (number of poles) of drive side magnets (the main drive side magnets 7b and the sub drive side magnets 7c and 7d) are made to be the same, but the present disclosure is not limited thereto. For example, the number (number of poles) of drive side magnets may be greater than the number (number of poles) of driven side magnets 6b.

(3) In the above embodiment, the driven side magnets 6b and the drive side magnets (the main drive side magnets 7b and the sub drive side magnets 7c and 7d) have a deformed columnar shape in which the outer diameters at both ends are larger than the outer diameter at the central portion, but the present disclosure is not limited thereto. Although a centrifugal force in accordance with the rotation acts on the driven side magnets 6b and the drive side magnets (the main drive side magnets 7b and the sub drive side magnets 7c and 7d) in a radial direction of the rotating shaft 3 and in a radial direction of the drive shaft 10, since the above-described deformed columnar shape is a device for more reliably holding the driven side magnets 6b and the drive side magnets (the main drive side magnets 7b and the sub drive side magnets 7c and 7d) on which a centrifugal force acts using the embedding holes, other shapes may also be used. For example, a deformed conical shape or a deformed columnar shape in which an outer diameter on a side close to the rotation central axes Lp and Lt is larger than an outer diameter on a side distant from the rotation central axes Lp and Lt may be used.

(4) In the above-described embodiment, the sub drive side magnets 7c and 7d functioning as thrust bearings with respect to the rotating shaft 3 (the driven side magnets 6b) are provided, but the present disclosure is not limited thereto. The sub drive side magnets 7c and 7d may be deleted as necessary.

(5) In the above-described embodiment, a drive source is the turbine T, but the present disclosure is not limited thereto. Instead of the turbine T, other power sources, for example, an electric motor may be used.

(6) In the above-described embodiment, the driven side magnets 6b, the main drive side magnet 7b, and the sub drive side magnets 7c and 7d are permanent magnets, but the present disclosure is not limited thereto. Instead of the permanent magnet, an electromagnet may be employed and a driving current may be supplied by using a slip ring or the like or by non-contact power feeding.

### INDUSTRIAL APPLICABILITY

According to the present disclosure, rocket fuel can be prevented from leaking through the rotating shaft of the rocket fuel pump.

What is claimed is:

1. A rocket fuel pump including a rotating body mounted on a rotating shaft and pressure-feeding rocket fuel when the rotating body is rotationally driven by a drive source, the rocket fuel pump comprising:
a magnetic coupling which is configured to magnetically couple the rotating shaft and a drive shaft of the drive source.

2. The rocket fuel pump according to claim 1, wherein
the magnetic coupling includes a driven side magnet provided on the rotating shaft and a drive side magnet provided on the drive shaft of the drive source, and
the driven side magnet and the drive side magnet are permanent magnets.

3. The rocket fuel pump according to claim 2, wherein
driven side magnets are provided in an annular shape at a predetermined angular pitch around a rotation central axis of the rotating shaft, and
drive side magnets are provided to face the driven side magnet and to have an annular shape with the same angular pitch as the driven side magnet.

4. The rocket fuel pump according to claim 2, wherein the drive side magnet includes:
a main drive side magnet facing the driven side magnet in a radial direction of the rotating shaft; and
sub drive side magnets disposed to sandwich the main drive side magnet in an extending direction of the rotating shaft and configured to have the same polarity as the driven side magnet.

5. The rocket fuel pump according to claim 3, wherein the drive side magnet includes:
a main drive side magnet facing the driven side magnet in a radial direction of the rotating shaft; and
sub drive side magnets disposed to sandwich the main drive side magnet in an extending direction of the rotating shaft and configured to have the same polarity as the driven side magnet.

6. The rocket fuel pump according to claim 2, further comprising a magnet cooling flow path which is configured to forcibly cool the driven side magnet using the rocket fuel.

7. The rocket fuel pump according to claim 3, further comprising a magnet cooling flow path which is configured to forcibly cool the driven side magnet using the rocket fuel.

8. The rocket fuel pump according to claim 4, further comprising a magnet cooling flow path which is configured to forcibly cool the driven side magnet using the rocket fuel.

9. The rocket fuel pump according to claim 5, further comprising a magnet cooling flow path which is configured to forcibly cool the driven side magnet using the rocket fuel.

10. The rocket fuel pump according to claim 1, further comprising a bearing cooling flow path in which the rocket fuel flows through a bearing which supports the rotating shaft.

11. The rocket fuel pump according to claim 2, further comprising a bearing cooling flow path in which the rocket fuel flows through a bearing which supports the rotating shaft.

12. The rocket fuel pump according to claim 3, further comprising a bearing cooling flow path in which the rocket fuel flows through a bearing which supports the rotating shaft.

13. The rocket fuel pump according to claim 4, further comprising a bearing cooling flow path in which the rocket fuel flows through a bearing which supports the rotating shaft.

14. The rocket fuel pump according to claim 5, further comprising a bearing cooling flow path in which the rocket fuel flows through a bearing which supports the rotating shaft.

15. The rocket fuel pump according to claim 6, further comprising a bearing cooling flow path in which the rocket fuel flows through a bearing which supports the rotating shaft.

16. The rocket fuel pump according to claim 7, further comprising a bearing cooling flow path in which the rocket fuel flows through a bearing which supports the rotating shaft.

17. The rocket fuel pump according to claim 8, further comprising a bearing cooling flow path in which the rocket fuel flows through a bearing which supports the rotating shaft.

18. The rocket fuel pump according to claim 9, further comprising a bearing cooling flow path in which the rocket fuel flows through a bearing which supports the rotating shaft.
